(19) United States
(12) Patent Application Publication
(10) Pub. No.: US 2005/0002727 A1
(43) Pub. Date: Jan. 6, 2005

(54) Ball and socket joint

(75) Inventors: Annette Nienaber, Muhlen (DE); Volker Grube, Diepholz (DE)

Correspondence Address: John James McGlew;McGLEW AND TUTTLE, Scarborough Station, Scarborough, NY, 10510-0827, US

(73) Assignee: ZF Lemforder Metallwaren AG

(21) Appl. No.: 10/909,866

(22) Filed: Aug. 2, 2004

Related U.S. Application Data
(63) Continuation of application No. PCT/DE03/02203, filed on Jul. 2, 2003.

(30) Foreign Application Priority Data
Jul. 3, 2002 (DE) DE 102 29 960.9

(51) Int. Cl. F16D 1/12

(52) U.S. Cl. 403/134

(57) ABSTRACT

A joint housing is provided. A pivot pin (1) includes a spherical surface (3) and a pivot part (2) and which is mounted with the spherical surface rotatably and deflectably in the joint housing (5). An elastic sealing bellows (8) surrounds the joint housing (5) or the pivot part (2) at least in a partial area. A static sealing seat (10) is formed between the pivot part (2) or the joint housing (5) and the sealing bellows (8) in this partial area. The sealing bellows (8) is fixed in the area of the sealing seat (10) by a nondetachable connection in substance, such as bonding or vulcanization. Optimal sealing of the static sealing between the pivot part/joint housing and the sealing bellows can be guaranteed by the embodiment according to the present invention.

### CROSS REFERENCE TO RELATED APPLICATION

This is a continuation of and claims the benefit (35 U.S.C. §120 and 365(c)) of copending International Application PCT/DE 2003/002203 of Jul. 2, 2003, which designated inter alia the United States and which claims the priority of German Application DE 102 29 960.9 of 3/July/2002. The entire contents of each application is hereby incorporated by reference in its entirety.

### FIELD OF THE INVENTION

The present invention pertains to a ball and socket joint, preferably for chassis suspensions and steering mechanisms of motor vehicles, with a joint housing, with a bearing journal, which comprises a spherical surface and a pivot part, and which is mounted with the spherical surface rotatably and defectably in the joint housing, and with an elastic sealing bellows, which surrounds the joint housing or the pivot part in at least one partial area, wherein an elastic sealing seat is formed in this partial area between the pivot part and the sealing bellows.

### BACKGROUND OF THE INVENTION

A great variety of embodiments of ball and socket joints of the type according to the class described are known from the state of the art. Since both a tilting movement and a rotary movement between the housing and the bearing journal take place in such ball and socket joints, the sealing of the bearing pair formed within the housing from the spherical surface of the bearing journal and a corresponding step bearing is usually achieved by means of a static sealing seat between the sealing bellows and the housing, and a dynamic sealing seat between the sealing bellows and the pivot part, which makes possible especially the rotary movement of the components in relation to one another. The embodiment of the static sealing seat makes provisions in case of prior-art solutions for the sealing bellows to be seated directly on a partial area of the jacket surface of the joint housing or the pivot part with a bead-like thickening formed at its end, which forms an inner sealing seat, the bellows surrounding the partial area, and it is optionally held there by the intrinsic stress of the material or by the tension of an outer, attached lock washer.

The general problem of such an embodiment is the fact that lifting off or displacement of the sealing bellows may occur because of relative movements in the area of the sealing seat, especially in case of great deflections, and the sealing action may thus be compromised. Moreover, there is a risk of corrosion on the pivot surface in the area of the sealing seat, because the pivot is usually made of metal and the surface of the sealing seat tends to undergo changes after a certain operating time despite a possibly existing coating applied for corrosion prevention, which ultimately leads to the failure of the sealing system and subsequently of the entire ball and socket joint due to the penetration of contaminants as a consequence of the defective sealing seat.

### SUMMARY OF THE INVENTION

An object of the present invention is therefore to achieve an improved sealing action in the area of the static sealing seat between the pivot part or the joint housing, and the sealing bellows of the ball and socket joint, which can be achieved especially by reducing relative movements between the components involved which form the sealing seat.

This object is accomplished with a ball and socket joint, preferably for chassis suspensions or steering mechanisms of motor vehicles, with a joint housing and a pivot pin. The pivot pin comprises a spherical surface and a pivot part. The pivot pin is mounted with the spherical surface rotatably and deflectably arranged in the joint housing. An elastic sealing bellows surrounds the joint housing or the pivot part in at least one partial area. An elastic sealing seat is formed in this partial area between the joint housing or pivot part, and the sealing bellows. The sealing bellows is fixed at the joint housing or pivot part by a nondetachable connection in substance in the area of the sealing seat. An important feature of these technical teachings is that the sealing bellows is fixed in the area of the sealing seat at the pivot part or at the joint housing by a nondetachable connection in substance.

A relative movement between the components forming the sealing seat is ruled out reliably by this embodiment according to the present invention, but a rotary and pendular movement can nevertheless take place between the bearing journal and the bearing shell because of the elasticity of the sealing bellows and of the additional dynamic sealing seat.

The connection in substance can be embodied corresponding to an advantageous embodiment of the present invention by a bonded connection or by the sealing bellows being vulcanized to the pivot part or to the joint housing.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is a sectional view through a ball and socket joint according to the present invention.

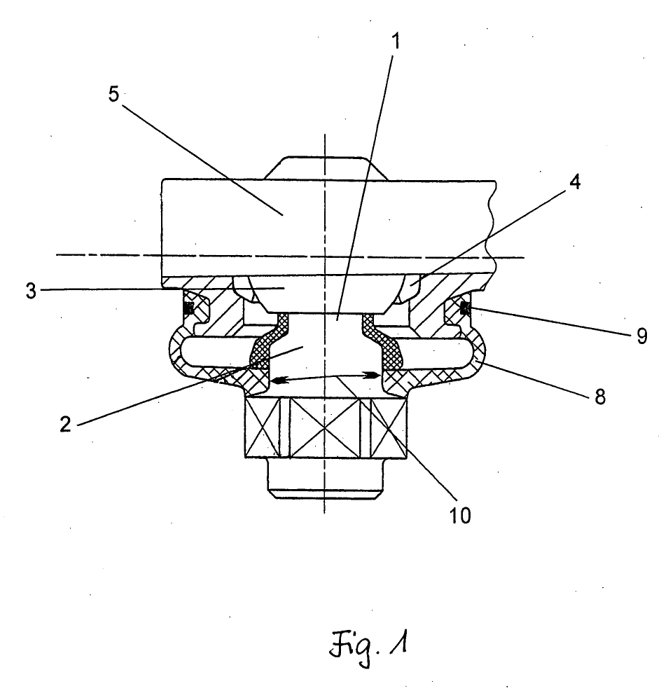

### DESCRIPTION OF THE PREFERRED EMBODIMENT

Referring to the drawing, the ball and socket joint has a pivot pin 1, which comprises a pivot part 2 and a spherical surface 3 made integrally in one piece therewith. The pivot pin 1 is mounted in the joint housing 5 of the ball and socket joint by means of a joint shell 4 made of a material with limited elasticity.

An elastic sealing bellows 8, one end of which is fastened dynamically in a circular groove on the circumference of the joint housing 5, so that tilting as well as especially rotary movements of the pivot pin are possible, is used for sealing between the joint housing 5 and the pivot pin 1. The other end of the sealing bellows 8 is provided with a sealing seat 10, which is used to sealingly join the sealing bellows 8 to the pivot part 2.

Compared with conventional embodiments, this sealing seat 10 is designed such that the sealing bellows is fixed in this area of the sealing seat at the pivot part 2 by a nondetachable connection in substance, and vulcanization or bonding is possible as an alternative.

A fixed connection is thus formed between the pivot part 2 and the sealing bellows 8, so that relative movements between the components forming the sealing seat 10 are ruled out. The lifting-off effects, which cause the sealing bellows 8 to lift off from the pivot part 2, which are caused by such relative movements, and the resulting leaks, can thus be reliably prevented from occurring.

As an alternative to this, a dynamic sealing seat is conceivable between the pivot part 2 and the sealing bellows 8, so that the sealing seat between the joint housing 5 and the sealing bellows 8 is designed according to the present invention as a connection in substance, i.e., the sealing bellows 8 is bonded or vulcanized to the joint housing 5.

While a specific embodiment of the invention has been shown and described in detail to illustrate the application of the principles of the invention, it will be understood that the invention may be embodied otherwise without departing from such principles.

### Appendix

List of Reference Numbers:

1 Pivot pin
2 Pivot part
3 Spherical surface
4 Joint shell
5 Joint housing
8 Sealing bellows
9 Lock washer
10 Sealing seat

1. A ball and socket joint comprising:
a joint housing;
a pivot pin with a spherical surface and a pivot part, said pivot pin is mounted with said spherical surface rotatably and deflectably in said joint housing;
an elastic sealing bellows surrounding said joint housing in at least one partial area;
an elastic sealing seat formed in said partial area between said joint housing and said sealing bellows, said sealing bellows being fixed at said joint housing by a nondetachable connection in substance in an area of said sealing seat.

2. A ball and socket joint comprising:
a joint housing;
a pivot pin with a spherical surface and a pivot part, said pivot pin is mounted with said spherical surface rotatably and deflectably in said joint housing;
an elastic sealing bellows surrounding said pivot part at least in a partial area;
a static sealing seat formed in said partial area between said pivot part and said sealing bellows, said sealing bellows being fixed at said pivot part by a nonidetachable connection in substance in an area of said sealing seat.

3. A ball and socket joint in accordance with claim 1, wherein:
said nondetachable connection in substance of said sealing bellows is a bonded connection.

4. A ball and socket joint in accordance with claim 2, wherein:
said nondetachable connection in substance of said sealing bellows is a bonded connection.

5. A ball and socket joint in accordance with claim 1, wherein:
said sealing bellows is vulcanized to said joint housing in said area of said sealing seat.

6. A ball and socket joint in accordance with claim 2, wherein:
said sealing bellows is vulcanized to said pivot part in said area of said sealing seat.

7. A ball and socket joint comprising:
a joint housing;
a pivot pin including a spherical surface and a pivot part, said pivot pin being rotatably and pivotally mounted in said joint housing;
a sealing bellows connected to said joint housing and said pivot pin, said sealing bellows sealing an interface between said pivot pin and said joint housing, said sealing bellows being permanently fixed to one of said joint housing and said pivot pin with a permanent connection.

8. A ball and socket joint in accordance with claim 7, wherein:
said permanent connection requires destruction of said sealing bellows for disconnection.

9. A ball and socket joint in accordance with claim 7, wherein:
said permanent connection blocks relative movement between said sealing bellows and said one of said joint housing and said pivot pin.

10. A ball and socket joint in accordance with claim 7, wherein:
said permanent connection is unconnectable during operation of the ball and socket joint.

11. A ball and socket joint in accordance with claim 7, wherein:
said permanent connection includes a chemical bond between said sealing bellows and said one of said joint housing and said pivot part.

12. A ball and socket joint in accordance with claim 7, wherein:
said permanent connection includes a vulcanized connection between said sealing bellows and said one of said joint housing and said pivot part.
